(19) United States
(12) Patent Application Publication
(10) Pub. No.: US 2020/0341752 A1
(43) Pub. Date: Oct. 29, 2020

(54) ELECTRONIC APPARATUS AND METHOD FOR CONTROLLING THEREOF

(71) Applicant: Samsung Electronics Co., Ltd., Suwon-si (KR)

(72) Inventors: Geunsik LIM, Suwon-si (KR); Myungjoo HAM, Suwon-si (KR); Jijoong MOON, Suwon-si (KR); Wook SONG, Suwon-si (KR)

(21) Appl. No.: 16/855,314

(22) Filed: Apr. 22, 2020

(30) Foreign Application Priority Data
Apr. 26, 2019 (KR) 10-2019-0049004

(51) Int. Cl. G06F 8/71; G06F 11/36

(52) U.S. Cl. CPC G06F 8/71; G06F 11/3604

(57) ABSTRACT

An electronic apparatus for automatically performing a source code review and a method thereof are provided. The electronic apparatus includes a communication interface, a memory storing at least one instruction, and at least one processor to control the communication interface. The at least one processor, by executing the at least one instruction, is configured to, based on a source code being submitted to a source code repository with a pull request, receive a webhook event message from the source code repository through the communication interface, download the submitted source code from the source code repository, extract a changed source code among the downloaded source codes, and perform a code review of the extracted source code through at least one inspection module.

### CROSS-REFERENCE TO RELATED APPLICATION(S)

This application is based on and claims priority under 35 U.S.C. § 119(a) to Korean patent application number 10-2019-0049004, filed on Apr. 26, 2019, in the Korean Intellectual Property Office, the disclosure of which is incorporated by reference herein in its entirety.

### BACKGROUND

### 1. Field

The disclosure relates to an electronic apparatus and a method for controlling thereof. More particularly, the disclosure relates to an electronic apparatus for automatically performing a source code review and a method for controlling thereof.

### 2. Description of Related Art

The appearance of a smart device popularized a concept of an application program store and update of a frequent software platform. Recently, the appearance of Internet of Things (IoT) devices has made the software platform update more frequently. A related-art smart device has user-oriented utility. However, the IoT device operates by itself and also operates in association with various peripheral devices and thus is composed of a lot of software.

In the past, the complexity of the software was not high because an embedded device only performed a simple operation to perform a particular function. However, the complexity of the single software is increasing in the IoT environment. As many developers are involved in single software development, developers spend more time in code review and code merging. In particular, in the IoT device, it is an obstacle that a lot of time is required for updating the software immediately when necessary due to security problems, function updates, bug fixes, or the like.

A continuous integration (CI) system maintaining code running from the beginning of development has prevented regression bugs in active development of software packages, including frequently updated device software platforms. However, the CI system has a problem that advanced hardware specification is necessary.

Accordingly, there is a need for an art that can quickly review code using relatively low system resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and provide at least the advantages described below. Accordingly, an aspect of the disclosure is to provide an electronic apparatus capable of automatically performing a code review in a low-specification environment based on a pull request and a method for controlling thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a communication interface, a memory storing at least one instruction, at least one processor to control the communication interface, The at least one processor, by executing the at least one instruction, is configured to, based on a source code being submitted to a source code repository with a pull request, receive a webhook event message from the source code repository through the communication interface, download the submitted source code from the source code repository, extract a changed source code among the downloaded source codes, and perform a code review of the extracted source code through at least one inspection module.

In accordance with another aspect of the disclosure, a method for controlling an electronic apparatus is provided. The method includes, based on a source code being submitted to a source code repository with a pull request, receiving a webhook event message from the source code repository through a communication interface, downloading the submitted source code from the source code repository, extracting a changed source code among the downloaded source codes, and performing a code review of the extracted source code through at least one inspection module.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic apparatus according to an embodiment of the disclosure;

FIG. 2 is a view illustrating a code review system according to an embodiment of the disclosure;

FIG. 3 is a view illustrating an operation of a webhook handler of FIG. 2 according to an embodiment of the disclosure;

FIG. 4 is a view illustrating an operation of a platform package builder of FIG. 2 according to an embodiment of the disclosure;

FIG. 5 is a view to describe a flow of a state transition of a pull request (PR) according to an embodiment of the disclosure;

FIG. 6 is a view to describe an operation of an inspector of FIG. 2 according to an embodiment of the disclosure;

FIG. 7 is a view to describe relevance between a modulator and an inspector according to an embodiment of the disclosure;

FIG. 8 is view to describe an operation of customizing of a plug-in module by a modulator according to an embodiment of the disclosure;

FIG. 9 is a flow chart to describe an operation of an electronic apparatus according to an embodiment of the disclosure;

FIG. 10 is a view to describe a memory consumption of an electronic apparatus according to an embodiment of the disclosure;

FIG. 11 is a view to describe a processing speed of an electronic apparatus according to an embodiment of the disclosure;

FIG. 12 is a view to describe the number of pull requests tested by an electronic apparatus according to an embodiment of the disclosure; and

FIG. 13 is a view to describe a central processing unit (CPU) usage of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this document, the expressions “have,” “may have,” “including,” or “may include” may be used to denote the presence of a feature (e.g., a component, such as a numerical value, a function, an operation, a part, or the like), and does not exclude the presence of additional features.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together. In addition, expressions “first”, “second”, or the like, used in the disclosure may indicate various components regardless of a sequence and/or importance of the components, will be used only in order to distinguish one component from the other components, and do not limit the corresponding components.

It is to be understood that an element (e.g., a first element) is “operatively or communicatively coupled with/to” another element (e.g., a second element) is that any such element may be directly connected to the other element or may be connected via another element (e.g., a third element). On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of” The expression “configured to” does not necessarily mean “specifically designed to” in a hardware sense. Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

Hereinbelow, the disclosure will be further described with reference to the drawings.

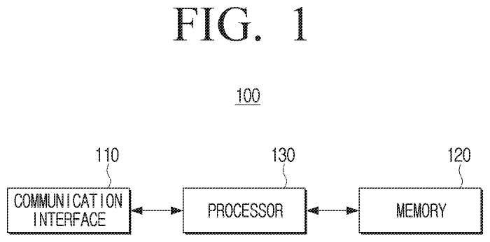

FIG. 1 is a block diagram illustrating a configuration of an electronic apparatus according to an embodiment of the disclosure.

Referring to FIG. 1, an electronic apparatus 100 includes a communication interface 110, a memory 120, and a processor 130.

The electronic apparatus 100 may be a server, desktop personal computer (PC), notebook, tablet PC, laptop PC, or the like.

A communicator or communication interface 110 (e.g., a transceiver) is configured to communicate with an external device. Communicating of the communication interface 110 with an external device may include communication via a third device (for example, a repeater, a hub, an access point, a server, a gateway, or the like). Wireless communication may include cellular communication using any one or any combination of the following, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM), and the like. According to an embodiment, the wireless communication may include, for example, any one or any combination of wireless fidelity (Wi-Fi), Bluetooth, Bluetooth low energy (BLE), Zigbee, near field communication (NFC), magnetic secure transmission, radio frequency (RF), or body area network (BAN). Wired communication may include, for example, a universal serial bus (USB), a high definition multimedia interface (HDMI), a recommended standard 232 (RS-232), a power line communication, or a plain old telephone service (POTS). The network over which the wireless or wired communication is performed may include any one or any combination of a telecommunications network, for example, a computer network (for example, local area network (LAN) or wide area network (WAN)), the Internet, or a telephone network.

Specifically, the communication interface 110 may communicate with a source code repository, which is an external device. Here, the source code repository means an infrastructure for receiving the source code from a developer and reviewing the code. For example, the source code repository be a GitHub. At this time, the developer can submit the source code to the source code repository using a pull request. Here, the pull request may mean that the developer submits the source code and desires to receive the code review. In the disclosure, the source code may be described in various terms, such as commit, task, work, or the like.

Another developer may complete the source code review and merge the review with a new code to improve the completeness of the code. As such, by reviewing the source code through the pull request, it is expected an effect of curing code detects and improving codes before merging the code.

Meanwhile, the communication interface 110 may receive a webhook event message from the source code repository, download the source code, and provide the developer with the feedback about the result of the code review. Here, the webhook means that, if a new event, which a client-side application program can be interested in, occurs at a server, a server-side application program provides a mechanism for informing to the client-side application program. The webhook is also referred to as “reverse application programming interface (API).” In the general API, a client calls the server, whereas in the case of webhooks, if a webhook registers with the server side calling the webhook (uniform resource locator (URL) provided by the client), the client may be called when a specific event occurs in the server.

The memory 120 may store instructions or data related to at least one another element of the electronic apparatus 100. The memory 120 may be implemented as a non-volatile memory, a volatile memory, a flash memory, a hard disk drive (HDD), a solid state drive (SSD), or the like. The memory 120 is accessed by the processor 130 and reading/writing/modifying/deleting/updating of data by the processor 130 may be performed. In the disclosure, the term memory may include the memory 120, read-only memory (ROM) in the processor 130, RAM, or a memory card (for example, a micro secure digital (SD) card, and a memory stick) mounted to the electronic apparatus 100. In addition, the memory 120 may store programs and data for controlling various screens to be displayed in the display area of the display of the electronic apparatus 100.

The memory 120 may store a plurality of inspection modules for source code review.

In the memory 120, a source code received from the source code repository for code review may be stored.

The processor 130 may be electrically connected to the communication interface 110 and the memory 120 and control overall operations and functions of the electronic apparatus 100. The processor 130 may perform code review by executing at least one instruction stored in the memory 120.

According to an embodiment, the processor 130 may be implemented as a digital signal processor (DSP), a microprocessor, and a time controller (TCON) for processing a digital image signal, but the processor 130 is not limited thereto. The processor 130 may include one or more among a central processing unit (CPU), a micro controller unit (MCU), a micro processing unit (MPU), a controller, an application processor (AP), a communication processor (CP), and an Advanced Reduced instruction set computing (RISC) Machine (ARM) processor or may be defined as a corresponding term. The processor 130 may be implemented in a system on chip (SoC) type or a large scale integration (LSI) type which a processing algorithm is implemented therein or in a field programmable gate array (FPGA).

Specifically, the processor 130 may receive a webhook event message from the source code repository via the communication interface 110 when the source code is submitted to the source code repository with the pull request. The processor 130 may then download the submitted source code from the source code repository.

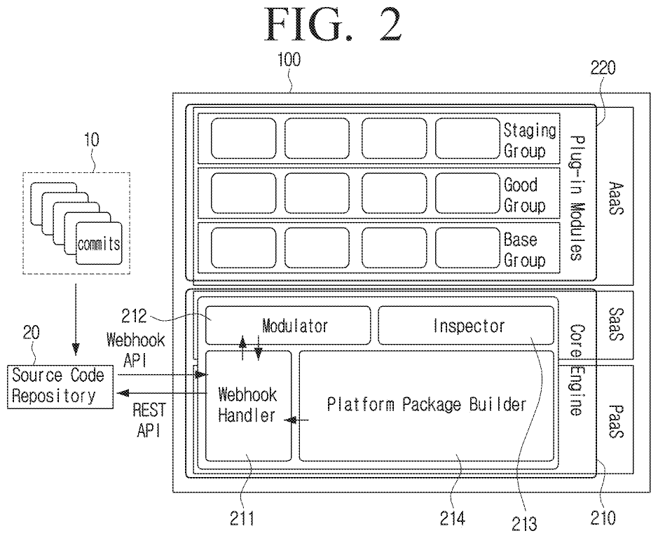

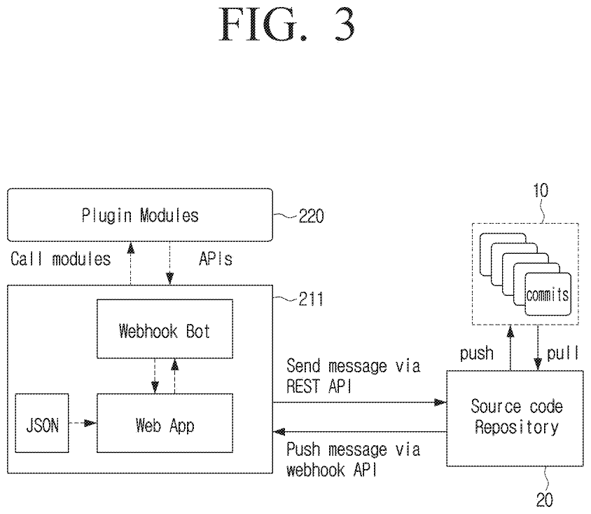

The processor 130 may integrate the process of repeatedly downloading the same source code. Specifically, the processor 130 may extract the modified source code other than the common source code among the downloaded source codes. The processor 130 may distribute the extracted source code to at least one inspection module to perform a code review. This operation may be performed by a webhook handler that is at least a part of the processor 130, and a detailed description will be described with reference to FIGS. 2 and 3.

The processor 130 may build at least one inspection module in a plug-in method. Here, the plug-in method can refer to a program that can be easily installed and used to add a specific function to existing software.

To be specific, although the source code repository has a common inspection module for performing the same function, different inspection modules may be required for each project. This allows the developer to easily add or remove a new test module using a plug-in method.

The processor 130 may sequentially use the at least one inspection module to perform a code review, and if an error is found, the processor 130 may stop the code review through the subsequent inspection module and provide feedback to the developer of the source code.

The plug-in module may be divided into a base group, a good group, and a staging group according to function and stability. That is, at least one inspection module can be classified into one of a basic group, a good group, and a staging group, and the processor 130 can perform a code review by using an inspection module included in each group in order of the basic group, the good group, and the staging group.

Since the related-art CI technology does not consider portability, it is difficult for a developer to reuse related-art modules in other projects, a large development time is required to modify the inspection module, and a developer had to develop additional modules using new creation rules and many API syntaxes. The electronic apparatus 100 according to the disclosure may use a plug-in structure to attach the CI module. The electronic apparatus 100 may easy to extend because it is a shell script that is familiar to most developers with just four APIs. This operation may be performed by a modulator that is at least a part of the processor 130, and a detailed description will be described in detail below with reference to FIG. 2.

If a plurality of pull requests are received, the processor 130 may run the build in the entered order, and if there is a task for the maximum number of pull requests in the build run queue, the task for the next incoming pull request may connect to a wait queue.

To be specific, the processor 130 may control the number of pull requests that can be simultaneously processed. The processor 130 manages a configuration file satisfying the hardware specification of the electronic apparatus 100. As a result, the processor 130 may minimize degradation in the system performance due to increase in the number of the pull requests.

The processor 130 may process the duplicate pull requests when repeatedly reprinting the modified pull request. Specifically, when the developer modifies the pull request to submit the same pull request, if there are a plurality of pull requests in the build run queue, the processor 130 may remove the task for the remaining pull request, except for the pull request entered at the end of the plurality of pull requests, in the entered order.

The processor 130 may terminate the same pull request task being executed first, based on a least recently used (LRU) algorithm. If the release schedule is reached, the number of redundant pull requests is increased, and there is no scheduling function and thus, the problem of the related-art pull request systems in which the merge rate of the source code was delayed may be overcome.

If the build is not completed for a predetermined period of time, the processor 130 may retransmit the task for the plurality of pull requests in the wait queue to the run queue. This is to solve the problem that the build is not completed even though the source code submitted by the developer is normal due to the temporary and unexpected instability of the system. Meanwhile, the operations described above can be performed by a platform package builder, which is at least a part of the processor 130, and a detailed description will be described in detail with reference to FIGS. 2, 4, and 5.

The processor 130 may perform an inspection of the source code through a part of the inspection modules among at least one inspection modules prior to the build, and if an error is detected, the processor 130 may provide a feedback to a developer without performing the build.

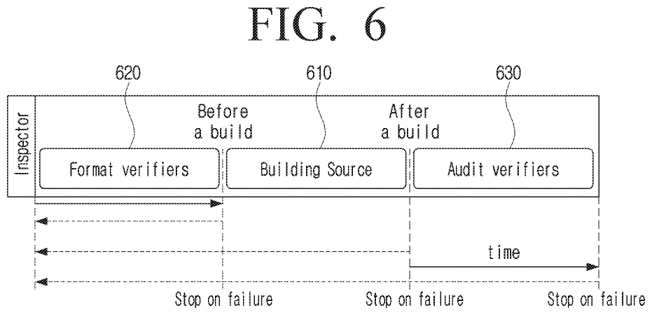

Specifically, the processor 130 may classify the inspection automation of the source code into two categories of prebuild and post-build. When tens of developers develop source code, many software defects can be found prior to building the software. If a code defect is found before the build, the cost of inefficient build-up of the software can be minimized since processing the code build process is not necessary. The processor 130 may be divided into a format check before the build and an audit checker after the build. This operation may be performed by an inspector that is at least a part of the processor 130, and a detailed description will be described in detail below with reference to FIGS. 2 and 6.

Though not illustrated in FIG. 1, the electronic apparatus 100 may further include a display, an input and output interface, or the like, according to an embodiment.

FIG. 2 is a view illustrating a code review system according to an embodiment of the disclosure.

Referring to FIG. 2, the code review system according to an embodiment may include a source code 10 prepared by a developer, source code repository 20, and the electronic apparatus 100.

When the source code 10 prepared by the developer is submitted to the source code repository 20, the electronic apparatus 100 may review the submitted source code 10. For example, the source code repository 20 may be the GitHub.

The electronic apparatus 100 may be composed of two blocks 210 and 220 for controlling the source code repository 20.

The electronic apparatus 100 may include a core engine 210 for performing a continuous integration (CI) process and an extensible engine including the base group, the good group, and the staging group.

The core engine 210 may be reviewed through the core configuration of the source code submitted by the developer. To be specific, the core engine 210 may include a webhook handler 211, a modulator 212, an inspector 213, and a platform package builder 214.

The extensible engine 220 may be a plug-in module that can be added or removed by a user. The extensible engine 220 may be composed of the base group, good group, and staging group according to a level of completeness of the module.

The source code repository 20 may send a webhook event message to the electronic apparatus 100 whenever the developer submits the created source code 10 to the source code repository 20, which is a common task management repository in the cloud environment. At this time, the webhook handler 211 may interpret the received event message and perform a task for processing the event. That is, each time the developer submits the source code 10, the webhook handler 211 may receive a standardized webhook event message in the source code repository 20. The webhook handler 211 may then forward the received event message to the inspector 213 via the modulator 212. The operation of the webhook handler 211 will be described in detail with reference to FIG. 3.

If the generated source code is a valid code, the electronic apparatus 100 may support a plug-in structure that allows a developer to add and delete an extensible function via the modulator 212. At this time, the supported plug-in equipment can be classified into three types as shown below and operated in order.
Plugin-base: Base modules that are maintained via plugin and plugout, but which are mandatorily required to be performed, belong to this group.
Plugins-good: Validated source code, well-defined functions, and modules that have passed high stability tests are located in this group.
Plugins-staging: Modules which do not have sufficient stability and functions for being completed but have a good function are included in this group. It means modules that may be moved to a plugins-good group when a review process and an aging test are completed.

When operation is not well performed in one module while inspecting the source code in the order of base, good, and staging group modules, the electronic apparatus 100 may provide a feedback to a developer, as operating a module subsequently is meaningless.

There are two groups, such as format and audit, to support the CI among inspecting, building and running. The following items show a format checker that can format a group to inspect defects before beginning a build process.
File size: It is possible to provide a file size checker that prevents upload of too large files in the source code repository. A care must be taken in uploading a large binary file called PITA in a source control management such as the Git.
New line: The end of the source code needs not include a new line at the end of the file description. The test program can verify the coding style if there is a new line each time a pull request is submitted.
No body: A developer should prepare a common description of at least four words. For example, a commit message may be made by referring to git-commit manual.
Signed-off: The developer should solve the license problem by running git commit-s . . . command. Signed-off-by: notation (signed-off-by: notation) should be included in both the 1) pull request body and the 2) commit Many open source communities basically use signed-by-by: notation to address the license problem that is the result of the contribution.
Clang-format: clang-format can be used to designate a format of C, C++, Java, JavaScript, Objective-C, and Protobuf code. In this disclosure, the clang format is used to keep the repository in a consistent code style, but a lot of noise can be avoided in the code review process. In this disclosure, coding rules wight clang-format-4.0 have been identified.
Doxygen-tag: A developer should include Doxygen style comments in the source code. For C and C++ codes, creators should include at least @file and @ brief tags in the source code. Creators should at least include the @package and @brief tags in the source code.
Doxygen-build: If Doxygen may generate a source code in general, Doxygen grammar is inspected.
Time stamp: A time stamp of the commit is identified.

When a file is to be modified, ntpdate.kr.pool.ntp.org command is run for synchronizing a local time of a desktop PC.
Hard-coded path: If hard-coded path is being submitted, failure is reported when it is not allowed in an original. Do not hard-code the path.
Running files: Confirm bits that can be run for .cpp, .h, .hpp, .c, .caffemodel, .prototxt and .txt. If there is a wrong running file in the commit, release the running bit.
RPM Spec: It is a tool for inspecting a general error of an RPM package. Prior to uploading, the RPM spec may be used for testing individual packages and spec files or inspecting the entire distribution.
Cppcheck: This is a static analysis tool for C/C++ code. The tool provides a unique code analysis that focuses on detecting bugs and detecting undefined behavior and dangerous coding configurations. The goal is to detect only real errors in the code (i.e. there are very few false positive.
Pylint: A programming error is sought and a coding standard is performed and a code smell of the Python can be got (as defined in the Refactoring book of Martin fowler). Pylint is a source code, a bug, and a quality inspector of the Python programming language.
Indent: Inspect a code format style by GNU indent.
Sloccount: Calculate physical source lines of code (SLOC). This is a tool set for calculating the real SLOC with a lot of languages of a potentially large program set.
Spelling error: Inspect whether there is a spelling error in a text document file using GNU Aspell.
Prohibited words: Inspect prohibited words if there is an unnecessary word in a source code.
Scancode: This is a series of code scanning tools for detecting a source and a license of a code and a dependency. One process flow is used.

The following items are in an audit group for inspecting a build state after completing a format group.
Builder: A builder executes compile of all the application programs.

That is, an application program is generated based on a specific software platform such as Ubuntu, Tizen, Yocto, and Android.
Resource: The entire resource file needs to be included in the RPM package. The resource removed from the repository can be removed.

Basically, the source code file must be independent of the CPU architecture. Before compilation, the source code must be able to be inspected by the inspector 213. When the developer submits the source code to the source code repository, the inspector 213 checks the source code level. In addition, the inspector 213 inspects the compiled binary file. By dividing the task into two operations before and after compilation, unnecessary resource waste of the CI server can be prevented. The operation of the inspector 213 will be described in more detail with reference to FIG. 6.

FIG. 3 is a view illustrating an operation of a webhook handler, illustrating that the webhook handler 211 processes a webhook message received from the source code repository 20 according to an embodiment of the disclosure.

Referring to FIG. 3, whenever a developer submits the created source code 10 to the source code repository 20 via a pull request, the webhook handler 211 may distribute the appropriate task using the plug-in module 220 because of the well-defined public API. If necessary, the developer can easily make its own custom module with reference to an existing shell-script-based module, such as Wiki philosophy.

In the electronic apparatus 100, if the developer submits the created source code 10 with the pull request, the CI module for inspecting a defect in the source code 10 should use hard ware resource as little as possible.

In general, each inspection module may perform different inspection tasks for a pull request. However, each inspection module may first perform a common task of downloading the source code in the source code repository 20 to identify the source code. This task not only results in unnecessary system load into the CPU and memory of the CI server, but can also produce the result of inefficient storing of the CI server. In particular, if the amount of source code 10 is large, it creates an issue that exceeds the storage space as well as the maximum number of unusable inodes of the file system.

Thus, the webhook handler 211 of the code review system according to the disclosure can run the download of the first source code in the source code repository 20 when the developer submits a pull request. Then, all inspection modules can be run while inspecting the source code with reference to the associated source. Currently, if the test module needs to perform a test that requires modification of the source code, only branching (e.g., git branching) using a copy-on-write mechanism (COW) mechanism can be performed.

This method may minimize the input/output (IO) operations of disk caused by additional cloning operations. These operations are performed by the same partition of the same file system and these operations do not generate unnecessary tasks of the superblock and block bitmap on the file system.

As the source code 10 must be merged into a build-enabled state, the code review system of the disclosure may include a platform package builder 214. For example, the platform package builder 214 may optionally support a package build of a software platform such as Ubuntu, Yocto, Tizen, or the like.

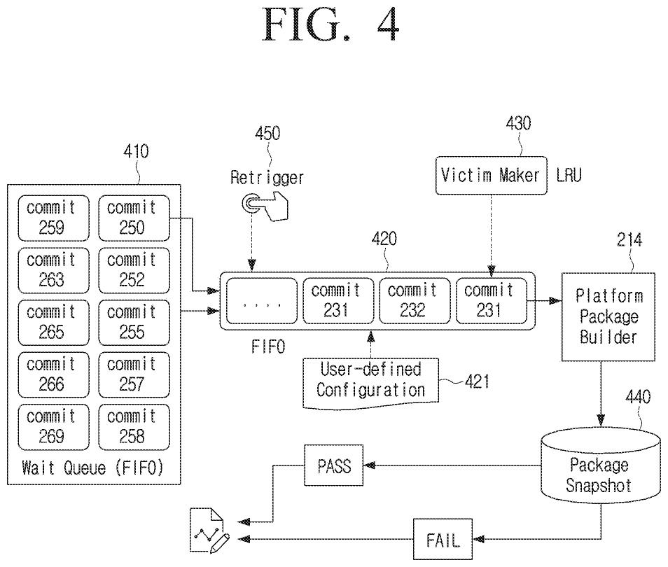

The electronic apparatus 100 of the code review system according to the disclosure may be activated when a developer creates a packaging script for a software platform. If the developer has to add another software platform, the developer may add a build module and thus provide scalability of the platform build. The operation of the platform package builder 214 will now be described in detail with reference to FIG. 4.

FIG. 4 is a view illustrating an operation of a platform package builder, illustrating the processing schedule of the submitted commit 410 according to an embodiment of the disclosure.

Referring to FIG. 4, a pull request scheduler 420 may process a requested commit 410 to build a package for various platforms. First, a developer can submit a source code to a source code repository as the pull request (PR). The pull request scheduler 420 may manage the lifetime and scheduling priority of the pull request by the run queue and an Out-of-PR (OOP) killer 430, and may not unnecessarily use hardware resources.

Specifically, the OOP refers to a state in which a pull request waits to receive a build ticket for performing a build task, since the pull request scheduler 420 does not process additional pull requests if the pull request queue is full. The OOP killer can manage pull requests that can be processed when a pull request is submitted. When a developer submits a pull request, the same pull request can often be resubmitted, because the developer modifies the source code of the submitted pull request or resubmits the pull request due to a newly discovered defect. At this time, the developer must modify the existing pull request and resubmit it to apply the reviewer's feedback before the build test of the previous pull request is completed.

In general, as the release time nears, the number of times a developer reprints and resubmits the same pull request as previously submitted increases. As the pull requests submitted by developers are modified and improved to make the pull requests more stable, a function to identify the submitted pull request increases.

To prevent server overload due to the submission of duplicate pull requests, the OOP killer was designed. The OOP killer may calculate the most recently submitted pull request with the most stable source code and provide a mechanism to remove the inspection task of the previously submitted pull request. At this point, a victim maker 430 may automatically terminate the oldest task in the run state using the OOP killer. For example, if a commit 231, which is the same commit, is input to the run queue in a duplicate manner, the victim maker 430 may first input old commit 231 as a common to be automatically terminated, and the OOP killer may terminate the determined commit. The victim maker 430 can use the LRU algorithm, and can identify the time in which the commit is input to the run queue in units of nanoseconds (ns).

The platform package builder 214 may build the commit in the order of the run queue, and if the build is completed, the package snapshot 440 may confirm whether the build is passed. When the build is passed, the source code is merged, and when the build is failed, feedback may be provided to the developer.

If the build is not completed despite that the submitted source code is normal, caused by a temporary and unexpected instability of the system, the build may be enabled to be passed by re-sending the entire commit back to the run queue through a retrigger 450.

If two or more source codes are generated in an isolated environment using virtualization technology, a lot of hardware resources are consumed, and thus, the code review system of the disclosure can recognize one folder as a root folder that can separately construct several source codes. A commit scheduler may prepare a necessary dependent package and then couple the source code to the package to set the structure for build and test. At least 90% of an embedded device may be an advanced RISC machine (ARM) CPU device, not an X86 CPU.

Smart devices such as smartphones, smart digital televisions (DTVs), smart watches and smart refrigerators, IoT and edge devices mainly use ARM CPUs, and each time a developer submits a pull request, many ARM CPU devices may be required to test on the actual ARM CPU. The code review system of the disclosure proposed to build and run ARM CPU based source code on a server based on the X86 CPU architecture is designed to run heterogeneous binary codes based on quick emulator (QEMU) and chroot.

The platform package builder 214 may control a merging request of the source code using two queues such as a wait queue and a run queue.

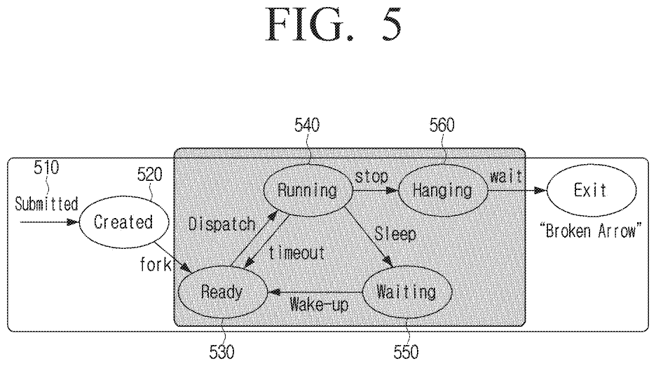

First, the wait queue can be designed with a first-in first-in first-out (FIFO) architecture that first executes a task in which a first merging request has entered a queue. If the task should be replaced before the wait queue, the run queue can be selected as a removal target. The run queue may then include a priority value for each merging request to be used by the pull request scheduler 420. At this time, the build can be performed in parallel as many as the number of run queues. The number of maximum run queues 421 may be configured by the user. When the task is successfully completed, the first request task waiting in the wait queue is moved to the run queue in order. The detailed flow of the task will be described in detail with reference to FIG. 5.

FIG. 5 is a view to describe a flow of a state transition of a pull request according to an embodiment of the disclosure.

Referring to FIG. 5, the pull request scheduler may manage a state transition of the pull request while performing the inspector such as a format group and an audio group to control overlapped pull requests.

When the pull request is submitted 510 by the developer, a pull request task may be created automatically to check the pull request whenever it is submitted. The created pull request tasks may be connected to a created queue 520.

The created pull request may then be in a ready state and connected to a ready queue 530. The pull request scheduler may select the pull request according to the FIFO scheduling policy and then change the state to a run state.

If the generated pull request task may be run, it may be coupled to a running queue 540. The pull request scheduler may execute all possible modules through the setting of the environment to execute the task that entered the run queue.

If too many pull requests are generated or the tasks are transited to a waiting state to use a lock system resource, the pull request task may be connected to a waiting queue 550.

A hanging state 560 is a state in which all system resources that are in use by the task are returned to the pull request scheduler, and the pull request state may be changed to an exit state, and the pull request PID can all be terminated.

FIG. 6 is a view to describe an operation of an inspector of FIG. 2 according to an embodiment of the disclosure.

Referring to FIG. 6, it may be identified that the inspector controls the inspection procedure for the pull request based on two divided inspection structures.

Specifically, the inspector may consist of two components, such as a format group 620 and an audit group 630. These two groups may be classified according to before or after the building procedure 610. When a pull request is closed by a developer or a viewer, an end-of-close (EOC) function may run an activity to delete an existing run queue.

Most source code defects may be found before the build is completed. The cost of building the source code to identify the disadvantages of the software requires many CPU and memory costs. Thus, the code review system according to the disclosure can perform static code analysis and convention inspection of the source code (format group 620), inform the developer immediately if source code defects are found, and determine whether to perform the next operation based on the build process (audit group) based on the available system resources of the server.

That is, if the pull request passes all of the inspection items of the format group 620, the build process 610 may always be performed as an essential procedure. Since the check point of the source code before and after the build process has been closely defined, the system resources of the electronic apparatus can be effectively used.
Format (before starting a build 610) 620: The platform package builder is executed before compiling the source. If the source code does not pass the format operation, the platform package builder is suspended without being executed. The developer can receive a report of the error of the source code.
Audit (after completing build 610) 630: When all the format modules are successfully completed for the source code, the source code enters an audio process. The inspector may inspect efficacy of the generated binary code after the source code is created.

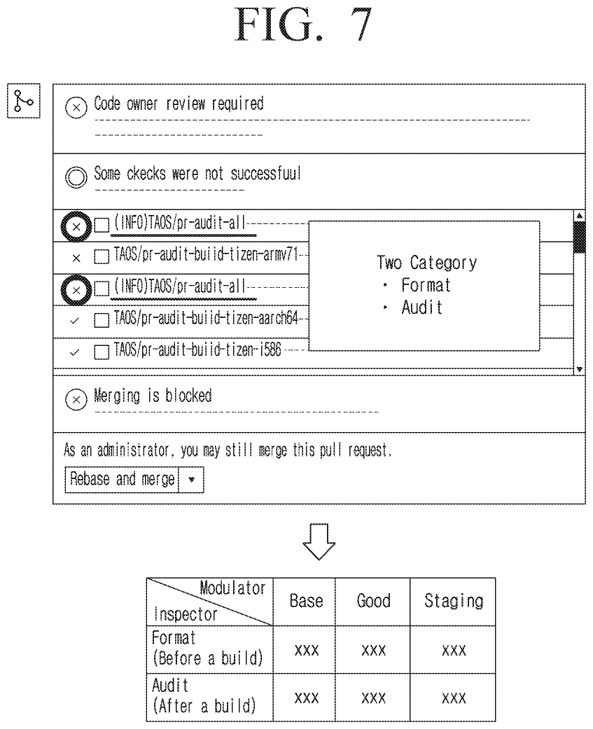

FIG. 7 is a view to describe relevance between a modulator and an inspector according to an embodiment of the disclosure.

Referring to FIG. 7, the modulator is a software device for managing three plug-in groups based on the maturity and stability of the module developed by the developer. This is to minimize damage to the system due to unexpected error whenever a developer creates a new module and adds them to three separate plug-in folders.

The inspector is a module for managing whether to a module developed by a developer is to be run before or after the build. The inspector may be used as a criterion to determine where to run the newly-added module.

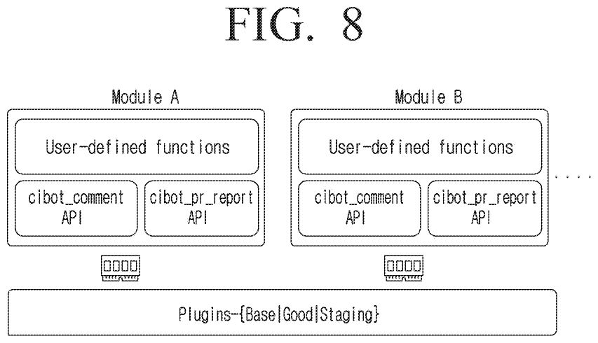

FIG. 8 is view to describe an operation of customizing of a plug-in module by a modulator according to an embodiment of the disclosure.

First, there are 30 test modules that are already well defined as basic plug-in modules. Various inspection modules may be required to inspect the code patch for each project, and the developer may deactivate or activate the module if necessary. The module can then be maintained and managed by three plug-in groups, such as basic, good, and staging.

Referring to FIG. 8, it can be seen that the modulator of the code review system supports a user-defined plug-in module for another target development repository. The disclosure provides a method of implementing a module in one of three folders as follows when a new CI module needs to be developed for a project.
Plugins-base: It is a group of well-managed CI plugins, including wide-range Tizen (gbs) and Ununtu (pdebuild).
Plugins-good: It is a set of plugins that are considered to have good quality code, the right functions, and the preferred license (Apache for plugin code).
Plugins-staging: It is a plugin set that is not the highest level as compared to other plugins, the quality thereof is close to a good quality, but there may be some missing points, and it may be a good code review, documentation, a series of tests or aging tests.

The following four requirements can be identified before the viewer merges the request when a request to merge the CI module into the main repository is submitted to ensure that an unexpected situation does not occur due to an unfamiliar new module.
Maintenance: After being activated through a configuration file, a module needs to be normally executed as the CI configuration element.
Readability: Most developers should read a source code of the CI module without a difficulty.
Running time: A time required to run a module should not be long.
Compatibility: A module should be executed not only in Ununtu but also in most of the Linux distributions.

As an embodiment, the custom module defined by the user can have four public APIs so that the webhook message can be transmitted to the GitHub website as follows.
cibot_comment( ) This API writes a requested message on a webpage of a request number or PR number.
cibot_report( ) API updates a current state of a module context.
goto_repodir( ) This API changes a folder position from a current directory to git repository directory.
check_dependency( ) This API confirms whether an essential command is installed in a server.

At this time, since the developer follows the Wiki philosophy, a new CI module can be easily developed with reference to the existing CI module without learning time.

In a method of testing a camera application program in an on-device AI, the number of application programs developed using deep learning technology has been increasing. The application program can perform learning or object recognition using an image frame collected in an actual camera device. Many installation and management costs may be required to connect the actual camera device each time a developer submits a camera recognition pull request. Accordingly, a virtual universal serial bus (USB) camera device is required to operate the camera device driver based on the loop back in the Linux kernel. In the disclosure, an existing loop back GStreamer was used in the loop back device, and the following two methods were designed and implemented to support this virtual test module in the cloud instance.

First, a virtual camera device can be created based on the media controller core of the Linux kernel. In a cloud instance, if there is no camera device, by inputting a system monitor screen or a media file, it may be operating as if a real USB camera receives a video frame. This allows an instance of a cloud server, such as an Amazon Web Services (AWS), Azure, and Google Cloud Platform (GCP), to verify that a pull request code works correctly without a peripheral device such as a USB camera.
v4l2l buffer: It has a structure to maintain a buffer of a loop back device.
v4l2 loop back device: It has a structure to maintain a state and setting of a loop back device.
v4l2 loopback opener: It has a structure to maintain a state and a type of an opener.
v4l2l format: It is greatly influenced by bttv driver discovered in the Linux kernel.

Most of the cloud instance does not provide a graphical user interface (GUI) monitor.

There is, therefore, a need for an appropriate approach to use a particular memory space as a virtual dummy display space. In the disclosure, a virtual monitor interface is generated based on virtual network computing and then a video of a camera application is output to a mock display space.
Producer: It is an X virtual network computing (VNC) server-based service application program capable of enabling use of a remotely-located computer by a camera GUI application program.
Consumer: The display variable is set to a variable that is running on the host in the GUI session (X, Wayland, or Mir). The client application then connects the manufacturer to open the session for the virtual display environment. Finally, the system executes all application programs.

The review system of the disclosure displays a current progress situation of a pull request submitted through a web interface based on a configuration file set by a user, a real-time Doxygen-based document, and a code application state. There is a potential security vulnerability in the current configuration file, as there is a general text file structure. The configuration file can be protected from abnormal access in the following two ways:
.htaccess-based folder access: The webhook handler processes and event message using the security information set by a user to determine whether access is normal. At this time, the security information is stored in Json format. The Json format files have a textual structure and thus, the proposed system controls web access to the folder where Json format files are stored based on the .htaccess of the web server.
Configuration file encoding: Each time a developer submits a pull request, the code review system of the disclosure can use the configuration file to manage the inspection module. At this time, since the information of the configuration file set by the user can be exposed to the outside through the web browser, the configuration file can be encrypted through the exclusive-OR (XOR) encoding algorithm.

The code review system of the disclosure has been designed so that the user can easily add and expand the CI inspection function to be added, and a new function is supported as a modular structure. For example, assuming that the developer attempts to link the cppcheck, which is one of the open source static analysis tools, the user completes the development of the new module by copying one of the already created modules and then connecting the cppcheck open source program to be used as the Wiki style.

The code review system may be executed independently through the lightweight webhook handler without an existing CI infrastructure.

In addition, if a user desires to maintain an existing CI infrastructure (such as Jenkins, Travis-CI, Circle-CI, and Azure-Pipeline), the CI manager can easily include the code review system into the infrastructure schedule. The proposed system is implemented using BASH and Curl, which is compatible with most OSs, and thus, the user only needs to connect the system's gateway script to the existing CI infrastructure execution area.

A method of performing runtest ARM binary in Ubuntu X64 for the Internet of Things (IOT)/edge computing, and the IoT and edge computing devices require low power. Therefore, most of these devices are designed and implemented based on the ARM CPU rather than the X86 architecture. Most CI servers, however, are largely based on the X86 CPU, since high performance is required for testing. The code review system supports testing of source code in the X86-based CI server by running a QEMU based software emulator to run heterogeneous device binaries. This disclosure does not optimize execution speed when running test binaries generated by creating submitted source code by running QEMU in the ARM kernel. After running heterogeneous ARM binary code directly in a user space based on host kernel, the operation of executable code is identified.

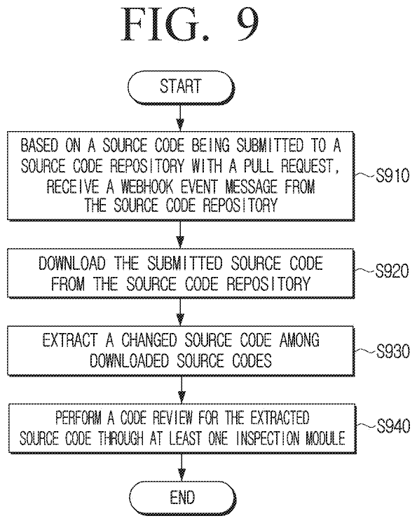

FIG. 9 is a flow chart to describe an operation of an electronic apparatus according to an embodiment of the disclosure.

Referring to FIG. 9, when the source code is submitted to the source code repository with the pull request, the electronic apparatus may receive a webhook event message from the source code repository in operation S910.

The electronic apparatus may download the submitted source code from the source code repository in operation S920.

The electronic apparatus may extract a changed source code other than the common source code among the downloaded source codes in operation S930.

The electronic apparatus may perform a code review for the extracted source code through at least one inspection module in operation S940. At this time, the electronic apparatus may distribute the extracted source code to at least one inspection module so that each inspection module performs a code review.

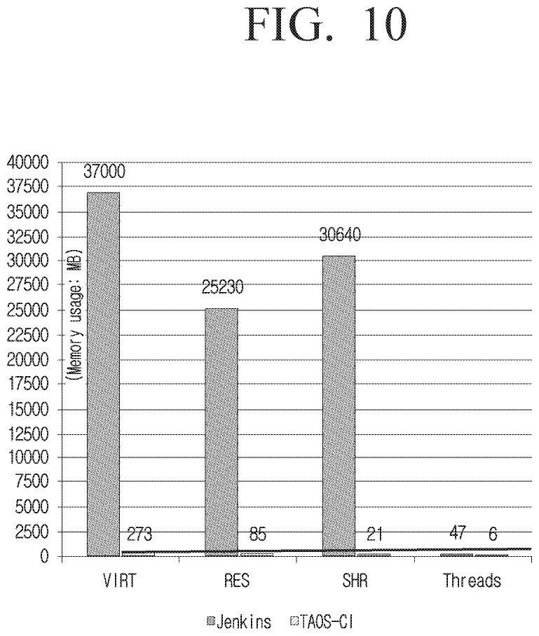

FIGS. 10 to 13 are views to describe an effect of the code review system and describe an experiment result using a general desk-top computer.

Specifically, the test bed is based on Intel Core i7-5820K processor (six cores, 12 threads, 3.3 GHz, 15 MB cache), Samsung DDR3 16 GB, SSD 850 PRO 512 GB (MZ-7KE512), Intel 1 Gbps Ethernet controller, and the operating system is installed with Ubuntu 16.04 LTS, Linux 4.4 and 1:1 Linux Thread Model (NPTL). The CPU policy was set to performance mode to reduce the impact of power management mechanisms.

The Intel Ethernet controller supports a theoretical maximum bandwidth of 1 Gbps, and to verify the efficiency of the code review system of the disclosure, Jenkins (existing public system) and LightSys (the code review system of the disclosure) are installed.

FIG. 10 is a view to describe a memory consumption of an electronic apparatus according to an embodiment of the disclosure.

Referring to FIG. 10, it can be identified that the code review system of the disclosure has substantially reduced memory consumption compared to the Jenkins which is the existing system. X axis includes four items as shown below.
VIRT: It means a total size of the virtual memory used in the task and means the size of the virtual set. This includes all code, data, and pages swapped with the shared library, and pages that have been mapped but not used.
RES: It means a resident set size. This is a not-swapped physical memory used by the task.
SHR: It means an amount of shared memory used by the task and means the size of the shared memory. It reflects a memory that can be shared potentially with another process.
Threads: It means the number of Linux threads.

Jenkins uses a JAVA-based system architecture because Jenkins focuses on a server-based extensible software architecture. The JAVA virtual machine-based execution architecture greatly increases memory usage. As a result of the analysis, Jenkins, which is an existing system, is not actually used, but it has been found to perform too many functions. It should be noted, however, that the code review system of the disclosure has nearly the same portability as compared to Jenkins. The code review system of the disclosure is composed of a BASH script and a PHP insurance script and can be used in many equivalent operating systems.

The memory usage of the server was compared when executing the server without rebooting the server for ten days. As a result of the experiment, the code review system of the disclosure has been able to solve frequent page playback and out of memory (00M) problems that may occur with system operation by using the minimum memory space as compared to existing system.

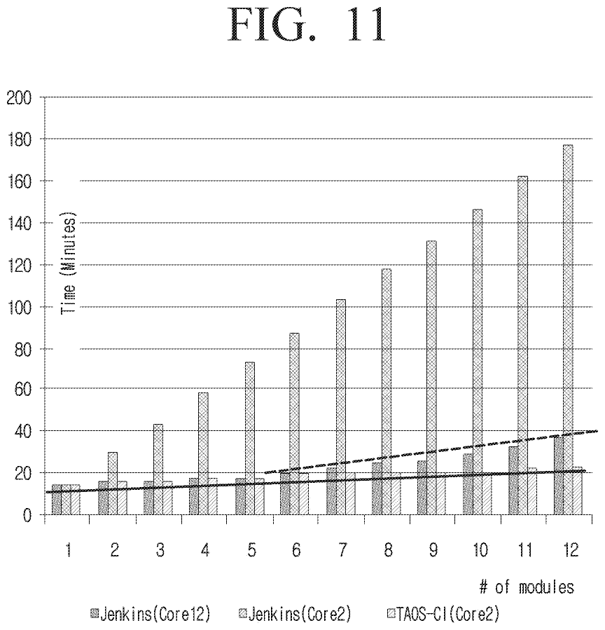

FIG. 11 is a diagram illustrating a processing speed of an electronic apparatus according to an embodiment of the disclosure. Specifically, in FIG. 11, the execution latency when attempting to combine different inspection modules is compared, and the compile latency of the Caffe, which is one of the widely used deep learning frame work is compared.

Referring to FIG. 11, the existing system has many redundant code routines, as there is no unit to manage the integrated module. In addition, since most modules are not integrated, a large amount of redundancy is generated between modules. It is very difficult to work based on common and shared tasks due to existing simple design structures. Also, the execution speed of the existing system at the compile time is directly dependent on the performance of the multi-core hardware.

In the existing system, if the number of CPUs can be assigned as many as the number of modules, the execution speed of the entire module can be improved. At this time, it should be executed in parallel. However, as the number of modules increases, the input/output (I/O) cost occurs, and thus the execution speed is gradually slowed down.

As a result of the analysis, the I/O bottleneck phenomenon of an existing system occurs at a point where the number of modules is six (see broken lines). As a result, there is a simple system design that tackles the high performance of solid state drive (SSD). In contrast, the code review system provides a modulator that consistently controls the functionality that the modules share and use in common. The modulator helps the developer to develop new modules by simplifying the implementation of new functions, and the developer can focus on the ability to develop.

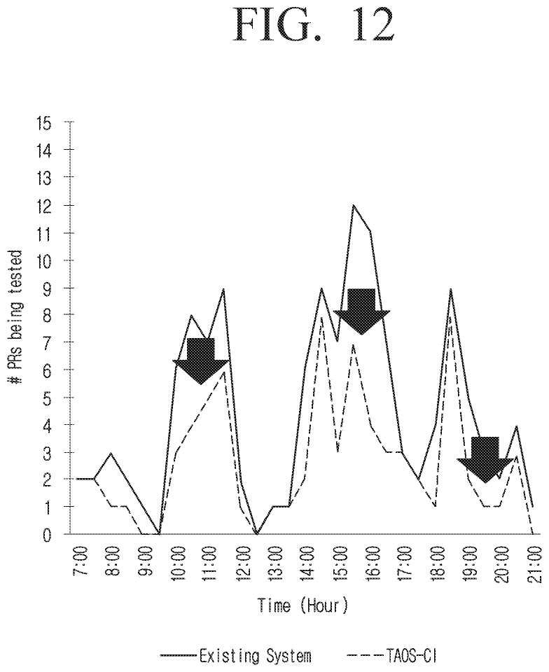

FIG. 12 is a view to describe the number of pull requests tested by an electronic apparatus according to an embodiment of the disclosure.

Most code patches can be inspected according to the bug and the wrong coding rules before beginning the code building procedure. Thus, the code review system (TAOS-CI) of the disclosure is designed and implemented in two operations. The first is the format inspection performed before performing the building procedure, and the second is an audit inspection performed after performing the building procedure.

Referring to FIG. 12, the experiment result between the existing system and the code review system of the disclosure may be identified. The code review system completely removes redundant or unnecessary task of the pull request.

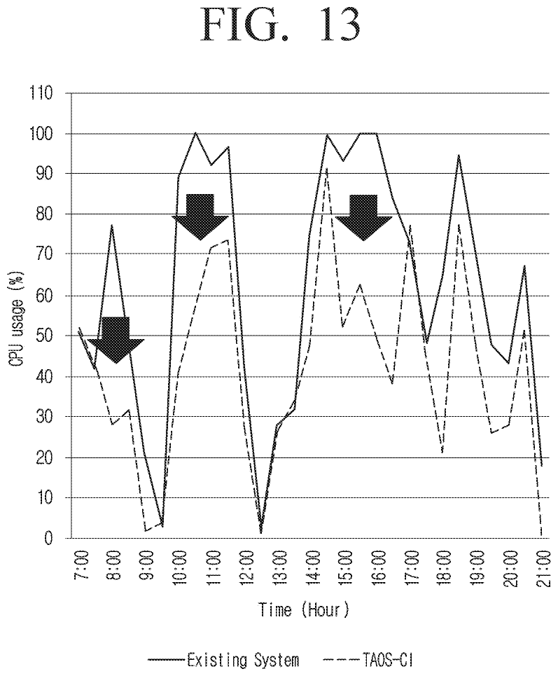

FIG. 13 is a view to describe a CPU usage of an electronic apparatus according to an embodiment of the disclosure.

Referring to FIG. 13, the code review system can consume hardware resources more effectively by introducing a state-of-the-art out-of-PR killer, as most of the resource shortages are due to meaningless build tasks. It may be identified how much CPU usage can be improved each time the pull request is submitted. The analysis showed that existing systems had CPU execution costs to run the infrastructure in addition to the tasks used to handle the pull requests. The existing system also had a former functional task structure that duplicated the code, rather than managing the code by the system in an integrated manner every time the pull request was submitted.

The term “part” or “module” as used herein includes a unit composed of hardware, software, or firmware, and is interchangeable with terms such as, for example, logic, logic blocks, components, or circuits. The “unit” or “module” may be an integrally constructed part or a minimum unit or part thereof that performs one or more functions. For example, the module may be configured as an application-specific integrated circuit (ASIC).

The various example embodiments as described above may be implemented with software including instructions stored in the machine-readable storage media readable by a machine (e.g., a computer). A machine is a device which may call instructions from the storage medium and operate according to the called instructions, and may include an electronic apparatus (example: electronic apparatus 100) of the embodiments. When the instructions are executed by a processor, the processor may perform a function corresponding to the instructions directly or by using other components under the control of the processor. The instructions may include a code generated by a compiler or a code executable by an interpreter. A machine-readable storage medium may be provided in the form of a non-transitory storage medium. Herein, the term “non-transitory” only denotes that a storage medium does not include a signal but is tangible, and does not distinguish the case in which a data is semi-permanently stored in a storage medium from the case in which a data is temporarily stored in a storage medium.

According to embodiments of the disclosure, a method disclosed herein may be provided in a computer program product. A computer program product may be traded between a seller and a purchaser as a commodity. A computer program product may be distributed in the form of a machine-readable storage medium (e.g., a compact disc (CD)-ROM) or distributed online through an application store (e.g., PlayStore™) In the case of on-line distribution, at least a portion of the computer program product may be stored temporarily or at least temporarily in a storage medium, such as a manufacturer's server, a server in an application store, a memory in a relay server, and the like.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments of the disclosure, may be performed sequentially, in a parallel, repetitive, or heuristic manner, or at least some operations may be performed in a different order, omitted, or other operations can be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a communication interface;
a memory storing at least one instruction; and
at least one processor to control the communication interface,
wherein the at least one processor, by executing the at least one instruction, is configured to:
based on a source code being submitted to a source code repository with a pull request, receive a webhook event message from the source code repository through the communication interface,
download the submitted source code from the source code repository,
extract a changed source code among the downloaded source codes, and
perform a code review of the extracted source code through at least one inspection module.

2. The electronic apparatus of claim 1, wherein the at least one processor is further configured to build at least one inspection module by a plug-in method.

3. The electronic apparatus of claim 2, wherein the at least one processor is further configured to:
perform a code review by sequentially using the at least one inspection module; and
based on detecting an error, stop the code review through a subordinate inspection module and provide a developer of the source code with a feedback.

4. The electronic apparatus of claim 3,
wherein each of the at least one inspection module is classified into any one of a base group, a good group, and a staging group, and
wherein the at least one processor is further configured to perform a code review using an inspection module included in each group in an order of the base group, the good group, and the staging group.

5. The electronic apparatus of claim 1, wherein the at least one processor is further configured to:
based on receiving a plurality of pull requests, run a build in an input order; and
based on a task for a maximum number of pull requests existing in a build run queue, connect a task for a pull request that is subsequently input to a wait queue.

6. The electronic apparatus of claim 5, wherein the at least one processor is further configured to, based on a plurality of same pull requests existing in a build run queue, remove a task for remaining pull requests except a pull request that is input lastly among the plurality of pull requests in an input order.

7. The electronic apparatus of claim 5, wherein the at least one processor is further configured to, based on a build not being completed in a preset time, re-transmit a task for the plurality of pull requests of the wait queue to the run queue.

8. The electronic apparatus of claim 1, wherein the at least one processor is further configured to;
perform an inspection through a part of inspection modules among the at least one inspection module before building; and
based on an error being detected, provide a developer with a feedback without performing building.

9. A method for controlling an electronic apparatus, the method comprising:
based on a source code being submitted to a source code repository with a pull request, receiving a webhook event message from the source code repository through a communication interface;
downloading the submitted source code from the source code repository;
extracting a changed source code among the downloaded source codes; and
performing a code review of the extracted source code through at least one inspection module.

10. The method of claim 9, further comprising:
building at least one inspection module by a plug-in method.

11. The method of claim 10, wherein the performing of the code review comprises:
performing a code review by sequentially using the at least one inspection module; and
based on detecting an error, stopping the code review through a subordinate inspection module and providing a developer of the source code with a feedback.

12. The method of claim 11,
wherein each of the at least one inspection module is classified into any one of a base group, a good group, and a staging group, and
wherein the performing of the code review comprises performing a code review using an inspection module included in each group in an order of the base group, the good group, and the staging group.

13. The method of claim 9, further comprising:
based on receiving a plurality of pull requests, running a build in an input order; and
based on a task for a maximum number of pull requests existing in a build run queue, connecting a task for a pull request that is subsequently input to a wait queue.

14. The method of claim 13, further comprising:
based on a plurality of same pull requests existing in a build run queue, removing a task for remaining pull requests except a pull request that is input lastly among the plurality of pull requests in an input order.

15. The method of claim 13, further comprising:
based on a build not being completed in a preset time, re-transmitting a task for the plurality of pull requests of the wait queue to the run queue.

16. The method of claim 9, further comprising:
performing an inspection through a part of inspection modules among at least one inspection module before building; and
based on an error being detected, providing a developer with a feedback without performing building.

17. A non-transitory computer-readable recording medium having recorded thereon at least one program comprising commands, which when executed by a computer, performs a method, the method comprising:
based on a source code being submitted to a source code repository with a pull request, receiving a webhook event message from the source code repository;
downloading the submitted source code from the source code repository;
extracting a changed source code among the downloaded source codes; and
performing a code review of the extracted source code through at least one inspection module.
